(19) United States
(12) Patent Application Publication
(10) Pub. No.: US 2016/0121898 A1
(43) Pub. Date: May 5, 2016

(54) METHOD OF CONTROLLING COASTING OPERATION OF HYBRID VEHICLE AND APPARATUS FOR PERFORMING THE SAME

(71) Applicant: Hyundai Motor Company, Seoul (KR)

(72) Inventors: Kyu Hwan Jo, Seoul (KR); Sang Joon Kim, Seoul (KR); Dong Pil Yoon, Incheon (KR); Dong Ho Yang, Geoje (KR); Joon Young Park, Seoul (KR)

(21) Appl. No.: 14/841,933

(22) Filed: Sep. 1, 2015

(30) Foreign Application Priority Data
Oct. 31, 2014 (KR) 10-2014-0149777

(51) Int. Cl. B60W 30/18; B60W 20/10

(52) U.S. Cl. CPC B60W 30/18072; B60W 20/10; B60W 2030/18081; B60W 2530/18; B60W 2520/10; Y10S 903/903

(57) ABSTRACT

A method of controlling coasting operation of a hybrid vehicle during a coasting operation and an apparatus for performing the same are provided. The coasting operation is controlled by calculating a remaining distance from a current location of a vehicle and a location at a target vehicle speed and an approach distance until reaching the target vehicle speed demanded at a current vehicle speed. Additionally, an inertia torque is adjusted to correspond to vehicle variation based on roads, slopes of the roads, and exterior disturbances. Thus, since inertia torque is adjusted during the coasting operation based on the target vehicle speed, unnecessary energy loss is reduced and fuel ratio is enhanced during traveling on roads.

### CROSS-REFERENCE TO RELATED APPLICATION

This application claims under 35 U. S. C. §119(a) the benefit of Korean Patent Application No. 10-2014-0149777 filed on Oct. 31, 2014, the entire contents of which are incorporated herein by reference.

### BACKGROUND

(a) Technical Field

The present invention relates to a method of controlling a coasting operation of a hybrid vehicle and an apparatus for performing the same. More particularly, the present invention relates to a method of controlling a coasting operation of a hybrid vehicle by applying vehicle speed that varies based on information regarding roads and traveling paths such that the demanded target coasting operation demanded is performed by calculating a remaining distance based on current vehicle speed and a demanded approach distance when decelerated according to a preset coasting operation line at the current vehicle speed during the coasting operation and an apparatus for performing the same.

(b) Background Art

To meet demands of high oil price increases, various controls such as energy regeneration and fuel cut during deceleration for the fuel ratio improvement have been developed. Furthermore, since traveling with effective fuel ratio based on road conditions enforcing vehicle speed deceleration and a deceleration input, relates to a method of controlling a coasting operation and an apparatus for performing the same has been researched. Vehicle manufacturers are striving to develop a vehicle that travels a maximum distance with minimum fuel consumption through the coasting operation.

In view of these backgrounds, the coasting operation is a driving method in which a vehicle is decelerated slowly without an accelerative intention using a driving energy. In a hybrid vehicle, since a battery may be charged using a motor during the coasting operation, the coasting operation is a principle factor for increasing the charging efficiency and in view of a fuel ratio. Additionally, recently, the decelerated state of a vehicle may be detected by receiving a traveling path of a vehicle and information regarding roads through an audio, video, and navigator system (AVN) within a vehicle. As a vehicle traveling system is developed, a technology of controlling a vehicle at a demanded vehicle speed has been used by controlling an inertia torque generated during the coasting operation.

However, when the coasting operation is performed using the traveling path of a vehicle and information regarding roads using the AVN system, variations of the vehicle speed caused by slopes of roads or outer disturbances may not be considered. In addition, when the vehicle speed varies due to the outer disturbance factors on the roads, an engine clutch or a brake is controlled to run the vehicle toward a desired location thus, deteriorating the effect of improving a fuel ratio during the coasting operation.

The related art discloses a coasting operation of presetting a braking distance and a temporal enabled distance of a coasting operation and performing the coasting operation less than the temporal enabled distance of a coasting operation and a traveling method of operating a vehicle at a lowest constant speed for the coasting operation when the vehicle is unable to reach a target location. However, the related art does not provide a technology of controlling the inertia torque based on the vehicle speed that varies due to road conditions during the coasting operation and may not improve a fuel ratio since the vehicle traveling at the lowest constant vehicle speed is demanded when the vehicle is unable to reach the target location.

### SUMMARY

Accordingly, the present invention provides a method of controlling a coasting operation of a hybrid vehicle by applying external conditions during the coasting operation by calculating a remaining distance from a current location of a vehicle and a location at a target vehicle speed and an approach distance until reaching the target vehicle speed demanded at a current vehicle speed, and by adding and reducing an inertia torque to correspond to vehicle variation of the vehicle based on roads, slopes of the roads, and exterior disturbances and an apparatus for performing the same.

In accordance with an aspect of the present invention, an apparatus for controlling a coasting operation of a hybrid vehicle may include: an audio, video, and navigator (AVN) unit configured to monitor a traveling path of the hybrid vehicle and road information; a driving unit configured to add and reduce an inertia torque; and a controller configured to receive information monitored by the AVN unit and a sensor unit, calculate a remaining distance to a location of a target vehicle speed, an approach distance demanded from a current vehicle speed to the target vehicle speed using a preset coasting operation line, a difference between the approach distance and the remaining distance during performance of the coasting operation, and perform an inertia torque adding and reducing control when the difference is greater than a preset value.

The inertia torque adding and reducing control may be performed by the controller according to following equation:

$$inertia torque reducing and increasing control = Asfactor ( \frac{( B - C )}{C} ) ,$$

wherein, A is an inertia torque generated during the coasting operation, B is a demanded approach distance except for a coasting distance from a current vehicle speed to when a vehicle stops and a coasting operation distance from an aimed vehicle speed to when a vehicle stops, and C is a remaining distance from a location at the current vehicle speed to a location at the target vehicle speed.

Further, the inertia torque adding and reducing control may be performed by reducing the inertia torque to decelerate the hybrid vehicle (e.g., reduce the speed of the vehicle) when the difference between the approach distance and the remaining distance is negative (e.g., less than zero). The inertial torque may be reduced by driving a motor or by engaging an engine clutch. In addition, the inertia torque adding and reducing control may be executed by increasing an inertia torque to decelerate the hybrid vehicle when the difference between the approach distance and the remaining distance is positive (e.g., greater than zero).

In accordance with another aspect of the present invention, a method of controlling a coasting operation of a hybrid vehicle may include: calculating a coating operation distance based on a current vehicle speed; calculating a deceleration demanded remaining distance from the coasting operation; determining whether an accelerator pedal is engaged; and performing an inertia torque adding and reducing control when the accelerator pedal is disengaged and when an absolute value of the difference between the approach distance and the remaining distance is greater than a second preset value, and maintaining a current coasting operation control when the absolute value of the difference between the approach distance and the remaining distance is less than a preset critical value.

When the absolute value of the difference between the approach distance and the remaining distance is greater than the second preset value, the inertia torque adding and reducing control may be performed by the controller according to following equation:

$$inertia torque reducing and increasing control = Asfactor ( \frac{( B - C )}{C} ) ,$$

wherein, A is an inertia torque generated during the coasting operation, B is a demanded approach distance except for a coasting distance from a current vehicle speed to when a vehicle stops and a coasting operation distance from a target vehicle speed to when a vehicle stops, and C is a remaining distance from a location at the current vehicle speed to a location at the target vehicle speed.

When the remaining distance is greater than the second preset value, the performance of the inertia torque adding and reducing control may include increasing an inertia torque to decelerate the hybrid vehicle when the difference between the approach distance and the remaining distance is positive (e.g., greater than zero). When the absolute value of the difference between the approach distance and the remaining distance is greater than the second preset value, the performance of the inertia torque adding and reducing control may include reducing the inertia torque to decelerate the hybrid vehicle when the difference between the approach distance and the remaining distance is negative (e.g., less than zero). The inertial torque may be reduced by driving a motor or by engaging an engine clutch.

The apparatus of the present invention provides a technology of adjusting an inertia torque by applying vehicle speed variations based on slopes on roads and external disturbances during the coasting operation and the vehicle speed to allow a vehicle to travel toward a location of a target vehicle speed traveling. Moreover, since the target vehicle speed demanded at the location of the target vehicle speed and the vehicle speed may be adjusted, a sense of difference caused by road conditions that cannot be applied during the coasting operation for reaching the demanded vehicle speed due to road disturbances may be reduced. In addition, since the present invention provides a technology of adjusting inertia torque during the coasting operation based on the target vehicle speed, unnecessary energy loss may be reduced and an enhanced fuel ratio may be obtained during traveling on roads.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is an exemplary view showing an existing method of controlling coasting operation based on a current vehicle speed according to the related art;

FIG. 2 is an exemplary block diagram showing an apparatus for controlling coasting operation of a hybrid vehicle according to an exemplary embodiment of the present invention;

FIG. 3 is an exemplary view showing a process of controlling an inertia torque by calculating a remaining distance and an approach distance during coasting operation in view of a vehicle speed according to an exemplary embodiment of the present invention; and

FIG. 4 is an exemplary flowchart showing a method of controlling coasting operation of a hybrid vehicle according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, the present invention will be described in detail so that those skilled in the art to which the present invention pertains may more easily carry out the present invention.

The present invention provides a method of controlling a coasting operation of a hybrid vehicle to calculate a remaining distance from a current location of a vehicle and a location at a target vehicle speed, a coasting operation distance until a vehicle stops from a current vehicle speed during the coasting operation, and a demanded approach distance except for the coasting operation distance from the target vehicle speed to when the vehicle stops, and of performing operations between the calculated values to operate the vehicle at a target vehicle speed demanded by a driver.

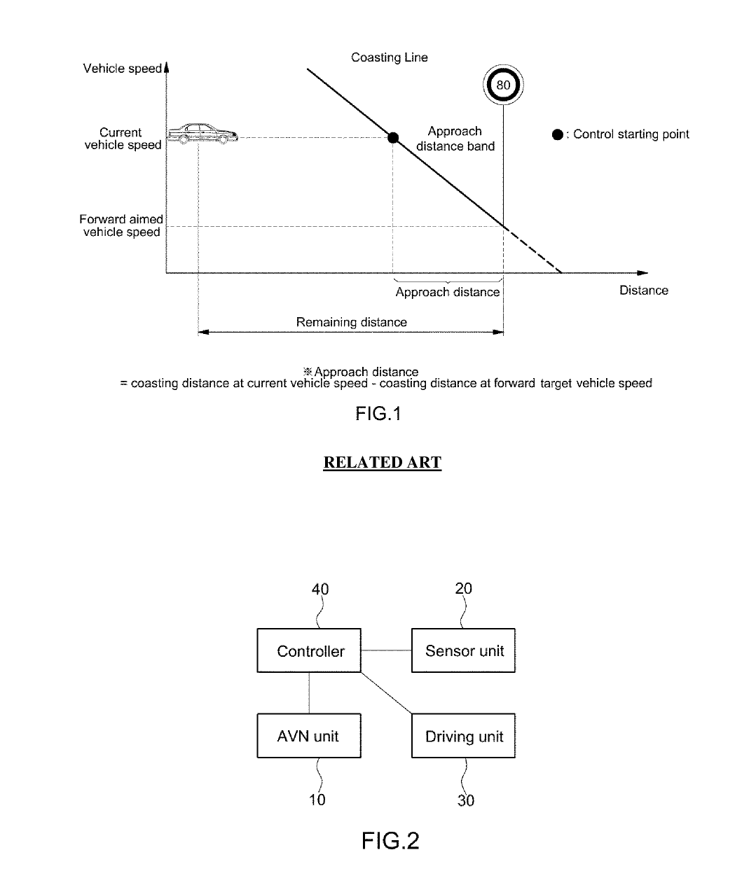

FIG. 1 shows an exemplary control process of performing coasting operation based on a current vehicle speed and an approach distance and a remaining distance calculated to control the coasting operation in the process of performing a coasting operation according to the related art. FIG. 2 is an exemplary block diagram showing an apparatus for controlling coasting operation of a hybrid vehicle according to an exemplary embodiment of the present invention.

The apparatus for controlling coasting operation of a hybrid vehicle may be configured to receive information regarding a traveling path of a vehicle and roads using an audio, video, and navigator system (AVN) 10. In particular, the traveling conditions may include situations when speed cameras and road linkages are expected. Accordingly, a controller 40 may be configured to receive traveling information of a vehicle such as the traveling path and information regarding roads from the AVN 10. In addition, Further, the controller 40 may be configured to calculate the remaining distance from a coasting operation controlling location to a forward location (e.g., a target location) of a target vehicle speed, based on the stored traveling data, and a demanded approach distance except for a coasting operation distance from a current vehicle sped to when a vehicle stops and a coasting operation distance from the target vehicle speed to when a vehicle stops during the coasting operation.

The apparatus for controlling coasting operation of a hybrid vehicle may include a sensor unit 20 configured to monitor the vehicle speed and whether an accelerator pedal is activated (e.g., whether the pedal is engaged or disengaged). The sensor unit may be configured to measure a current vehicle speed using an acceleration sensor, a vehicle speed sensor, and a wheel speed sensor. Accordingly, the vehicle speed may be measured to set a starting time point of the coasting operation and an approach distance for performing the coasting operation to the target vehicle speed using a preset and stored coasting operation line. The engagement degree of an accelerator (e.g., the amount of pressure exerted onto the acceleration pedal) may be measured using an accelerator position sensor (APS) and the coasting operation may be performed by the controller 40 when the accelerator is fully engaged.

As described above, the traveling path of a vehicle and road information may be obtained using the AVN 10 and a current vehicle speed and the engagement degree an accelerator may be measured by the sensor unit 20 and the obtained information and the measured values may be to the controller 40. The controller 40, based on the input information and the measured values, may be configured to calculate a remaining distance from a current location of a vehicle to a forward location (e.g., a target location) of a target vehicle speed, a coasting operation distance from the current vehicle speed to when a vehicle stops, and a demanded approach distance except for a coasting operation distance from the target vehicle speed to when a vehicle stops. In other words, the controller 40 may be configured to calculate a coasting operation-performing zone and the approach distance to reduce a vehicle speed to the target vehicle speed and perform an inertia torque adding and reducing operation in the coasting operation-performing zone based on the calculated remaining distance and approach distance. The controller 40 may be a hybrid control unit (HCU). In addition, the forward location of a target vehicle speed may be considered as a target location reached by the vehicle traveling at a target speed.

The inertia torque adding and reducing control performed by the controller 40 may be calculated by following equation:

$$inertia torque reducing and increasing control = Asfactor ( \frac{( B - C )}{C} )$$

wherein, A is an inertia torque generated during the coasting operation, B is a demanded approach distance except for a coasting distance from a current vehicle speed to when a vehicle stops and a coasting operation distance from a target vehicle speed to when a vehicle stops, and C is a remaining distance from a location at the current vehicle speed to a location at the target vehicle speed.

In the process of performing a coasting operation, the controller 40 may be configured to calculate an inertia torque adding and reducing control values based on the above equation. In particular, the controller may be configured to perform the inertia torque adding and reducing operation by considering a relationship between the remaining distance to the target vehicle speed and the approach distance to the target vehicle speed based on a coasting operation line preset in the controller 40.

In performing the inertia torque adding and reducing control during the coasting operation, since the inertia torque may be increased to reduce the vehicle speed when the approach distance is greater than the remaining distance, the controller may be configured to increase a charging amount of a motor connected to an axle. However, in a system-restricted situation such as a motor-charging restricted situation, a target torque may be satisfied by engine-clutch engagement.

Furthermore, since a vehicle may be accelerated by reducing the inertia torque when the approach distance is less than the remaining distance during the coasting operation, the charging amount of a motor connected to an axle may be reduced. However, when the system-restricted situation such as a motor-charging restricted situation, the inertia torque adding and reducing control may be performed by transmitting a driving power through the engine-clutch engagement.

Accordingly, in performing the inertia torque adding and reducing control during the coasting operation, a driving unit 30 may be used as a device to adjust the inertia torque. The driving unit 30 may include a motor unit connected to the axle and an engine clutch engaged with an engine. Thus, under the conditions where an inertia torque is to be reduced, the controller 40 may be configured to adjust the charging amount of the motor unit or an inertia torque by engaging the engine clutch with the axel. Thus, during the adjustment of an inertia torque, in a hybrid vehicle, an inertia torque may be adjusting by changing the charging amount of a motor. In other words, the inertia torque may increase when the charging amount of a motor is increased and the inertia torque may decrease when the charging amount of a motor is reduced. In addition, the engagement of the engine clutch may be performed to enable the inertia torque adding and reducing operation.

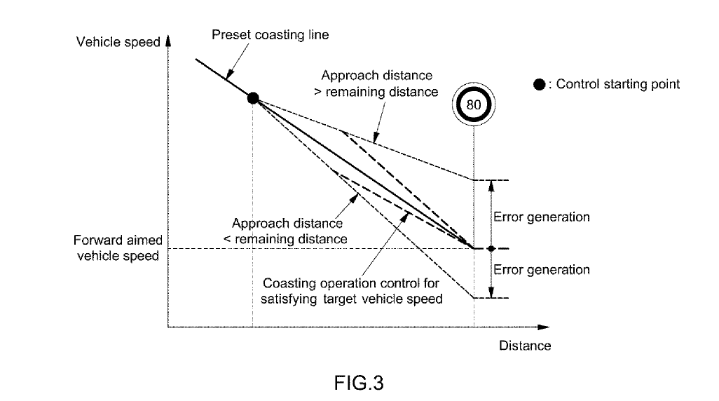

FIG. 3 is an exemplary view showing change of a vehicle speed through the inertial torque adding and reducing control during the coasting operation. Thus, when the approach distance is greater than the remaining distance during the coasting operation, the controller 40 may be configured to increase the inertia torque, and as a result of decreasing the vehicle speed, a vehicle may travel toward a location where the forward target vehicle speed is required at a vehicle speed demanded by a driver. In addition, when the approach distance is less than the remaining distance during the coasting operation, the inertia torque may be reduced and a vehicle speed may be increased to allow a vehicle to pass through a location where a target vehicle speed is required as demanded by a driver.

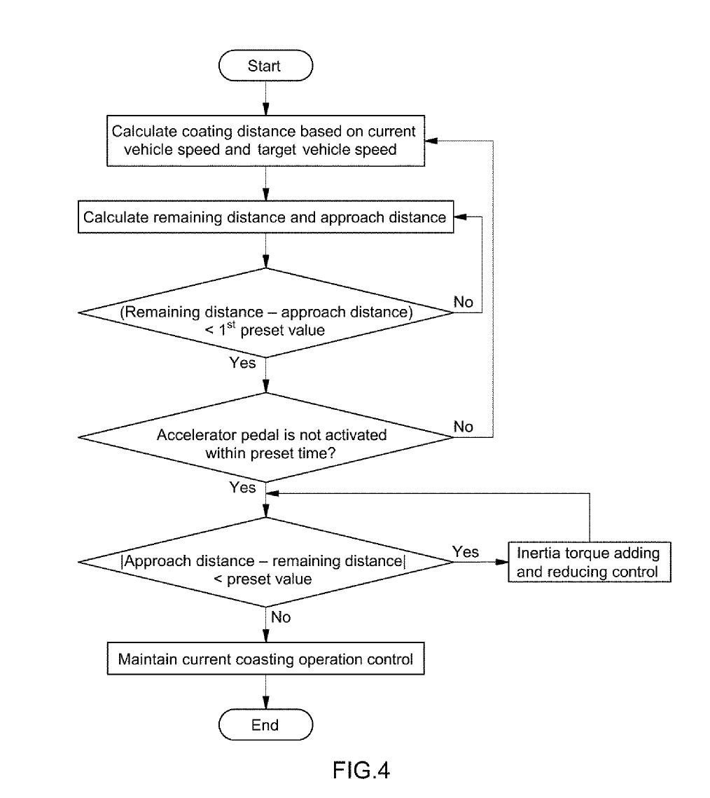

FIG. 4 is an exemplary flowchart showing a method of controlling coasting operation of a hybrid vehicle according to an exemplary embodiment of the present invention. The method of controlling coasting operation of a hybrid vehicle may include calculating a coasting operation distance based on a current vehicle speed and a target vehicle speed (S110) and a remaining distance from a current location of a vehicle and to a location at the target vehicle speed and an approach distance demanded when a vehicle speed is reduced from the current vehicle speed to the target vehicle speed during the coasting operation (S120).

Further, whether a difference between the remaining distance and the approach distance is less than a first preset value preset may be determined (S130), and the calculation of the remaining distance and the approach distance during the coasting operation may be repeated when the difference between the remaining distance and the approach distance is greater than the first preset value. When the difference between the remaining distance and the approach distance is less than the first preset value, whether an accelerator pedal is engaged within a preset time may be determined (S140).

When the accelerator pedal is disengaged, the calculation of the coasting operation distance based on the current vehicle speed and the target vehicle speed (S110) may be repeated. When the accelerator pedal is engaged, since the coasting operation may be performed, whether the difference between the approach distance and the remaining distance during the coasting operation is greater than a second preset value preset may be determined (S150). Additionally, when the difference between the approach distance and the remaining distance during the coasting operation is less than the second preset value, the current coasting operation may be maintained (S160). When the difference between the approach distance and the remaining distance during the coasting operation is greater than the second preset value, an inertia torque adding and reducing control (S170) may be performed.

Further, when the difference between the approach distance and the remaining distance during the coasting operation is greater than the second preset value, during the inertia torque adding and reducing control (S170), the inertia torque may be increased to decelerate a vehicle when the difference between the approach distance and the remaining distance is positive (e.g., greater than zero). When the difference between the approach distance and the remaining distance is negative (e.g., less than zero), the inertia torque may be reduced to accelerate the vehicle. When the vehicle is accelerated by reducing the inertia torque, the motor may be driven and the charging amount of the motor may be reduced to decrease the inertia torque or the engine clutch may be engaged to reduce the inertia torque to accelerate the vehicle.

Although the method of controlling a coasting operation of a hybrid vehicle and the apparatus for performing the same according to the present invention has been described in detail, the scope of the present invention is not limited to the description but various modifications made by those skilled in the art using the basic concept of the present invention defined by the claims also fall within the scope of the present invention.

What is claimed is:

1. An apparatus for controlling a coasting operation of a vehicle, the apparatus comprising:
an audio, video, and navigator (AVN) unit configured to monitor a traveling path of the vehicle and road information;
a driving unit configured to add and reduce an inertia torque; and
a controller configured to receive information monitored by the AVN unit and a sensor unit, calculate a remaining distance to a location of a target vehicle speed, an approach distance demanded from a current vehicle speed to the target vehicle speed through a preset coasting operation line, a difference between the approach distance and the remaining distance during performance of the coasting operation, and perform an inertia torque adding and reducing control when the difference is greater than a preset value.

2. The apparatus of claim 1, wherein in the calculation of the approach distance by the controller, the controller is configured to calculate the approach distance using data of a difference between a coasting operation distance demanded from the current vehicle speed to when the vehicle stops by the coasting operation line preset in the controller and a coasting operation distance demanded from the target vehicle speed to when the vehicle stops.

3. The apparatus of claim 1, wherein the inertia torque adding and reducing control is performed based on following equation:
$$inertia torque reducing and increasing control = Asfactor ( \frac{( B - C )}{C} ) ,$$
wherein, A is an inertia torque generated during the coasting operation, B is a demanded approach distance except for a coasting distance from a current vehicle speed to when a vehicle stops and a coasting operation distance from a target vehicle speed to when a vehicle stops, and C is a remaining distance from a location at the current vehicle speed to a location at the target vehicle speed.

4. The apparatus of claim 3, wherein the controller is configured to decelerate the vehicle by increasing the inertia torque when the approach distance is greater than the remaining distance during the performance of the inertia torque adding and reducing control.

5. The apparatus of claim 3, wherein the controller is configured to accelerate the vehicle by reducing the inertia torque when the approach distance is less than the remaining distance during the inertia torque adding and reducing control.

6. The apparatus of claim 5, wherein the controller is configured to decrease a charging amount of a motor or engage an engine clutch to reduce the inertia torque during the performance of the inertia torque adding and reducing control.

7. The apparatus of claim 1, wherein the sensor unit is configured to monitor the vehicle speed and whether an accelerator pedal is engaged.

8. A method of controlling a coasting operation of a vehicle, the method comprising:
calculating, by a controller, a coating operation distance based on a current vehicle speed;
calculating, by the controller, a remaining distance from a location at a current vehicle speed and a location at a target vehicle speed and an approach distance demanded from the current vehicle speed to the target vehicle speed during the coasting operation;
determining, by the controller, whether a difference between the remaining distance and the approach distance is less than a first preset value;
calculating, by the controller, the remaining distance when the difference between the remaining distance and the approach distance is greater than the first preset value and determining whether an accelerator pedal is engaged when the different between the remaining distance and the approach distance is less than the first preset value; and
calculating, by a controller, a coating operation when the difference between the remaining distance and the approach distance is greater than the first preset value, performing an inertia torque adding and reducing control when the different between the remaining distance and the approach distance is less than the first preset value and an absolute value of the difference between the approach distance and the remaining distance is greater than a second preset value, and maintaining a current coasting operation control when the absolute value of the difference between the approach distance and the remaining distance is less than a preset critical value.

9. The method of claim 8, wherein in the calculation of the demanded from the current vehicle speed to the target vehicle speed during the coasting operation, the approach distance is calculated using a difference between a coasting operation distance demanded from the current vehicle speed to when the vehicle stops by a coasting operation line preset in the controller and a coasting operation distance demanded from the target vehicle speed to when the vehicle stops.

10. The method of claim 8, wherein when the absolute value of the difference between the approach distance and the remaining distance is greater than the second preset value, the inertia torque adding and reducing control is performed by the controller according to following equation:
$$inertia torque reducing and increasing control = Asfactor ( \frac{( B - C )}{C} ) ,$$
wherein, A is an inertia torque generated during the coasting operation, B is a demanded approach distance except for a coasting distance from a current vehicle speed to when a vehicle stops and a coasting operation distance from a target vehicle speed to when a vehicle stops, and C is a remaining distance from a location at the current vehicle speed to a location at the target vehicle speed.

11. The method of claim 8, wherein when the absolute value of the difference between the approach distance and the remaining distance is greater than the second preset value, the performance of the inertia torque adding and reducing control includes:
increasing, by the controller, an inertia torque to decelerate the vehicle when the difference between the approach distance and the remaining distance is greater than zero.

12. The method of claim 8, wherein when the absolute value of the difference between the approach distance and the remaining distance is greater than the second preset value, the performance of the inertia torque adding and reducing control includes:
reducing, by the controller, the inertia torque to decelerate the vehicle when the difference between the approach distance and the remaining distance is less than zero.

13. The method of claim 12, wherein the inertial torque is reduced by increasing a charging amount of a motor or by engaging an engine clutch.

14. A non-transitory computer readable medium containing program instructions executed by a controller, the computer readable medium comprising:
program instructions that calculate a coating operation distance based on a current vehicle speed;
program instructions that calculate a remaining distance from a location at a current vehicle speed and a location at a target vehicle speed and an approach distance demanded from the current vehicle speed to the target vehicle speed during the coasting operation;
program instructions that determine whether a difference between the remaining distance and the approach distance is less than a first preset value;
program instructions that calculate the remaining distance when the difference between the remaining distance and the approach distance is greater than the first preset value and determining whether an accelerator pedal is engaged when the different between the remaining distance and the approach distance is less than the first preset value; and
program instructions that calculate a coating operation when the difference between the remaining distance and the approach distance is greater than the first preset value, perform an inertia torque adding and reducing control when the different between the remaining distance and the approach distance is less than the first preset value and an absolute value of the difference between the approach distance and the remaining distance is greater than a second preset value, and maintain a current coasting operation control when the absolute value of the difference between the approach distance and the remaining distance is less than a preset critical value.

15. The non-transitory computer readable medium of claim 14, wherein in the calculation of the demanded from the current vehicle speed to the target vehicle speed during the coasting operation, the approach distance is calculated using a difference between a coasting operation distance demanded from the current vehicle speed to when the vehicle stops by a coasting operation line preset in the controller and a coasting operation distance demanded from the target vehicle speed to when the vehicle stops.
